(19) United States
(12) Patent Application Publication
(10) Pub. No.: US 2005/0133135 A1
(43) Pub. Date: Jun. 23, 2005

(54) Tire with sidewall having at least one internal rubber insert having graduated physical properties comprised of overlapping rubber segments

(76) Inventors: Filomeno Gennaro Corvasce, Mertzig (LU); Jean Luc Dheur, Arlon (BE); Thierry Koeune, Fauvillers (BE); Francois Philippe Depouhon, Arlon (BE); Gia Van Nguyen, Rossignol (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/992,867

(22) Filed: Nov. 19, 2004

Related U.S. Application Data
(60) Provisional application No. 60/530,538, filed on Dec. 18, 2003.

(51) Int. Cl. B60C 17/00; B60C 15/06; B60C 13/00

(52) U.S. Cl. 152/517; 152/541; 152/555

(57) ABSTRACT

This invention relates to pneumatic tires having a sidewall which contains at least one internal annular rubber insert. In particular, this invention relates to pneumatic tires which rely upon internal pneumatic air pressure and to pneumatic tires which conventionally rely upon internal pneumatic air pressure but which have a capability of running for extended distances without any significant internal air pressure, namely ambient atmospheric air pressure, depending somewhat upon the positioning and configuration of the sidewall insert. At least one of said rubber sidewall inserts is composed of two segments, namely a radially inner rubber segment and a radially outer rubber segment. The inner rubber segment and outer rubber segment have significantly different modulus and hardness physical properties. A portion of the segments overlap each other. In one aspect, each of the segments of the dual segment sidewall insert may be comprised of various types of rubber compositions containing, for example, a dispersion of an ultra high molecular weight polyethylene and/or a dispersion of a starch/plasticizer composite and/or mixtures of carbon black and silica and/or any reinforcing and non-reinforcing materials that could be used to tune the gradient of stiffness.

The Applicants hereby incorporate by reference prior U.S. Provisional Application Ser. No. 60/530,538, filed on Dec. 18, 2003.

### FIELD OF THE INVENTION

This invention relates to pneumatic tires having a sidewall which contains at least one internal annular rubber insert. In particular, this invention relates to pneumatic tires which rely upon internal pneumatic air pressure and to pneumatic tires which conventionally rely upon internal pneumatic air pressure but which have a capability of running for extended distances without any significant internal air pressure, namely ambient atmospheric air pressure, depending somewhat upon the positioning and configuration of the sidewall insert. At least one of said rubber sidewall inserts is composed of two segments, namely a radially inner rubber segment and a radially outer rubber segment. The inner rubber segment and outer rubber segment have significantly different modulus and hardness physical properties. A portion of the segments overlap each other. In one aspect, each of the segments of the dual segment sidewall insert may be comprised of various types of rubber compositions containing, for example, a dispersion of an ultra high molecular weight polyethylene and/or a dispersion of a starch/plasticizer composite and/or mixtures of carbon black and silica and/or any reinforcing and non-reinforcing materials that could be used to tune the gradient of stiffness.

### BACKGROUND OF THE INVENTION

It is sometimes desired to provide a pneumatic tire with a sidewall having a relatively high stiffness, or high modulus and hardness physical properties, to enhance a tire's handling, for example its cornering stability, when mounted on a rigid rim as a part of a wheel of a vehicle. For example, see U.S. Pat. Nos. 4,024,901 and 4,067,373.

Rubber inserts in a form of apexes in tire sidewalls are typically used to provide a graduated stiffness in the sidewall as it extends radially outward from the tire bead portion. The graduated stiffness aspect of the sidewall insert is conventionally provided by presenting the apex in a tapered configuration, namely by providing it with a relatively thick base which tapers to smaller dimensions as it extends radially outward into the sidewall and its stiffness thereby decreases proportionally.

Pneumatic tire sidewall apexes are typically used to provide a graduated stiffness in the sidewall as it extends radially outward from the tire bead portion. The graduated stiffness aspect of the sidewall insert is conventionally provided by presenting the apex in a tapered configuration, namely by providing it with a relatively thick base which tapers to smaller dimensions as it extends radially outward into the sidewall. Pneumatic tire rubber apexes and their use in adding stiffness for a tire sidewall are well known to those having skill in such art.

Rubber sidewall inserts in a form of inserts spaced apart from and extending radially outward from such tire sidewall apexes are sometimes used to add stiffness to the tire sidewall, particularly where it may be desired to provide support for the sidewall of a pneumatic tire which is designed to run for a distance without internal air pressure, namely atmospherically ambient air pressure. Use of such spaced apart sidewall rubber inserts are well known to those having skill in such art.

For this invention, however, it is desired to modify the graduated stiffness aspect of the tapered sidewall insert configuration by presenting the tapered insert in a form of two co-extruded, radially aligned, integral, rubber segments of rubber compositions having differing physical properties which partially overlap each other, thereby providing not only a graduated stiffness based upon a tapered configuration of the rubber insert but, also, by both the overlapping zone presented between the two segments and a differing stiffness of the rubber compositions of the individual segments themselves. For such purpose, it is desired that the respective rubber composition of the radially inner and outer segment of the tapered insert is adapted to the local type of solicitations. For example, for a rubber insert in a form of an apex, the rubber composition of the radially inner segment of the tapered insert desirably has stiffer compression properties than the radially outer segment, and the radially outer segment desirably has softer tension properties than the radially inner segment.

On the other hand, in a rubber insert in a form of a sidewall insert which is spaced apart from a sidewall apex, the rubber composition of the radially inner segment of the spaced apart, tapered, sidewall insert often desirably has softer tension properties than the radially outer segment of the spaced apart sidewall insert, and the radially outer segment of the insert often desirably has stiffer compression properties than the radially inner segment.

In practice, a conventional tire sidewall rubber insert may, for example, be in a form of a relatively stiff annular apex, of a graduated thickness configuration which might, for example, be of an entruncated substantially crescent shape, which extends from a rigid bead portion of a pneumatic tire radially outward into the tire sidewall to both provide a graduated lateral stiffness to the sidewall for tire handling purposes and to provide a transition of stiffness from the bead portion to the more flexible sidewall portion of the tire.

Alternately, a conventional sidewall rubber insert may be in a form of an annular rubber insert of a graduated thickness configuration, which is spaced apart from the rigid bead portion, as well as the sidewall apex, of a pneumatic tire and is contained within the tire sidewall to add a graduated stiffness to the sidewall for various purposes such as, for example, where it is desired to provide a tire with resistance to running flat under a reduced internal air pressure such as, for example, atmospheric pressure.

For this invention, it is desired to provide a tapered rubber sidewall insert having a graduated transition of physical properties which does not rely entirely upon a tapered shape of the insert.

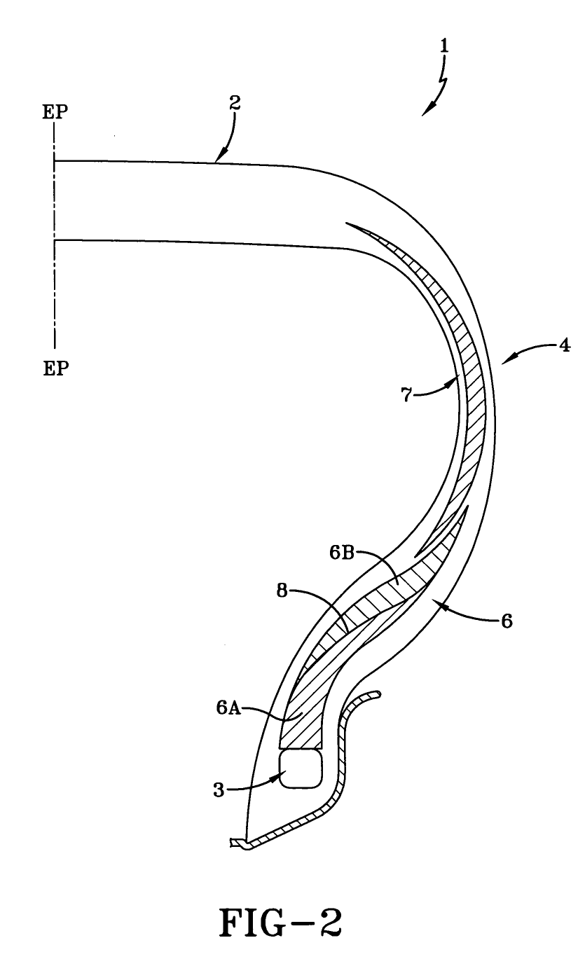

Historically, U.S. Pat. No. 5,871,602, in part, relates to a tire sidewall which contains an insert which is composed of an apex portion and an insert portion which extends radially outward from the apex portion in which the apex portion and insert portion may be of different elastomeric materials and which, according to FIG. 2B therein, may, in a partial overlapping configuration with each other.

U.S. Pat. No. 5,511,599 relates, in part, to a tire sidewall which contains a bead filler which can be contiguous with a crescent shaped reinforcing member in a manner that they may be one unitary homogeneous material or they may be separate components with the bead filler having a higher hardness and modulus of elasticity. In its FIG. 2, it appears that they may be in a partial overlapping configuration with each other.

In the description of this invention, while the term “pneumatic tire” generally refers to a tire of a open torroid shape which is supported by an internal air pressure when mounted on a rigid rim, it is also intended herein to relate to such a tire in which the air pressure is reduced to atmospheric pressure so that the tire is not supported by air pressure which is greater than atmospheric pressure.

The term “phr” where used herein, and according to conventional practice, refers to “parts of a respective material per 100 parts by weight of rubber. In the description of this invention, the terms “rubber” and “elastomer” can be used interchangeably, unless otherwise indicated. The terms “rubber composition”, “compounded rubber” and “rubber compound” can be used interchangeably to refer to “rubber which has been blended or mixed with various ingredients and materials” and such terms are well known to those having skill in the rubber mixing or rubber compounding art.

The referenced 100 percent ring modulus and shore D hardness value may be determined according to ASTM D-4120 and ASTM D-2240, respectively, at 23° C.

### DISCLOSURE AND SUMMARY OF THE INVENTION

A pneumatic tire is provided which is comprised of a circumferential tread, two spaced apart beads, and sidewalls connecting said beads and tread, wherein said tire sidewall contains at least one internal annular sidewall insert composed of a co-extruded first segment and a second segment, wherein a portion (less than 100 percent) of said first segment and a portion (less than 100 percent) of said second segment are in a overlapping configuration with each other with a diagonal interface therebetween to form an overlapping zone,
(A) wherein for first and second rubber segments of said sidewall insert;
   (1) the rubber composition of said first rubber segment has a 100 percent ring modulus at 23° C. within a range of about 10 to about 20 MPa and a Shore D hardness value at 23° C. within a range of about 35 to about 55;
   (2) the rubber composition of said second rubber segment has a 100 percent ring modulus at 23° C. within a range of about 3 to about 12 MPa and Shore D hardness value at 23° C. within a range of about 25 to about 35;
   (3) said 100 percent ring modulus of said rubber composition of said first rubber segment is at least five MPa greater than said 100 percent ring modulus of the rubber composition of said second rubber segment; and
   (4) said Shore D hardness of said rubber composition of said first rubber segment is at least five units greater than the Shore D hardness of the rubber composition of said second rubber segment;
(B) wherein said tire sidewall contains:
   (1) an apex composed of said sidewall rubber insert extending from a tire bead radially outward into said tire sidewall, wherein said first rubber segment of said apex is a radially inner component thereof and said second rubber segment of said apex is a radially outer component thereof, or
   (2) an apex and an additional said sidewall rubber insert wherein said additional sidewall insert is spaced apart from said apex, extends radially outward and axially inward from said apex in an overlapping relationship therewith, wherein
      (a) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
      (b) for said spaced apart sidewall insert, said first rubber segment of said spaced apart sidewall rubber insert is a radially outer component thereof and said second rubber segment of said spaced apart sidewall rubber insert is a radially inner component thereof, or
   (3) an apex and an additional said sidewall rubber insert wherein said additional sidewall insert is spaced apart from said apex, extends radially outward and axially inward from said apex in an overlapping relationship therewith, wherein
      (a) said apex extends radially outward from a tire bead into a tire sidewall, wherein said apex is of a unitary rubber composition, and;
      (b) for said spaced apart sidewall insert, said first rubber segment of said spaced apart sidewall rubber insert is a radially outer component thereof and said second rubber segment of said spaced apart sidewall rubber insert is a radially inner component thereof, or
   (4) an apex and an additional said sidewall rubber insert wherein said additional sidewall insert is spaced apart from said apex, extends radially outward and axially inward from said apex in an overlapping relationship therewith, wherein
      (a) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
      (b) said spaced apart sidewall insert is comprised of a unitary rubber composition, or
   (5) an apex and an additional said sidewall rubber insert wherein said additional sidewall insert is spaced apart from said apex, extends radially outward and axially inward from said apex in an overlapping relationship therewith, wherein
      (a) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
      (b) for said spaced apart sidewall insert, said second rubber segment of said spaced apart sidewall rubber insert is a radially outer component thereof and said first rubber segment of said spaced apart sidewall rubber insert is a radially inner component thereof, or
   (6) an apex and an additional said sidewall rubber insert wherein said additional sidewall insert is spaced apart from said apex, extends radially outward and axially inward from said apex in an overlapping relationship therewith, wherein
      (a) said apex extends radially outward from a tire bead into a tire sidewall, wherein said apex is of a unitary rubber composition, and;
      (b) for said spaced apart sidewall insert, said first rubber segment of said spaced apart sidewall rubber insert is a radially inner component thereof and said second rubber segment of said spaced apart sidewall rubber insert is a radially outer component thereof.

It is to be appreciated that the tire sidewall typically contains at least one cord reinforced rubber ply. In practice, at least one of said plies is positioned between said apex and said spaced apart sidewall rubber insert. Typically, the spaced apart sidewall insert is positioned adjacent to and axially inward of at least one of said plies. Typically, said apex is positioned adjacent to and axially outward of at least one of said plies. Such plies in a in a pneumatic tire, which typically extend from bead-to-bead through the crown of the tire (said crown portion of the tire being, in general, the portion of the tire radially inward of the tire tread) and which add support and stability to various components of the tire, are well known to those having skill in such art.

In practice, said overlapping zone in said sidewall rubber insert may comprise from about 20 to about 50 percent of the radial length of each of said segments of said sidewall rubber insert and from about 10 to 30 percent of the radial length of the sidewall rubber insert.

In practice, therefore, the sidewall rubber insert may be characterized by a radially graduated stiffness (radially graduated 100 percent ring modulus and Shore D hardness physical properties of the sidewall rubber insert) formed by significant differences between the 100 percent ring modulus and Shore D hardness of the radially aligned individual segments in a cooperative combination with the said overlapping configuration (overlapping zone) of the two segments.

One envisioned aspect of such significant rubber properties of the individual segments of the sidewall rubber insert is to provide a tire with a relatively balanced handling characteristic.

Another envisioned aspect is the placement of said segmented spaced apart sidewall insert to provide a graduated stiffness in a mid to upper portion of the sidewall.

In practice, the physical properties of each of the individual segments of the apex and/or spaced apart sidewall rubber insert may be adjusted, tuned or customized by selection of appropriate combinations of elastomers and reinforcing fillers, and optionally one or more additional reinforcing and/or non-reinforcing materials (e.g. clays and short fibers), without undue experimentation by one having skill in such art in order to obtain the inserts with appropriate physical properties.

In one alternative and optional aspect of the invention, at least one of said radially inner and outer segments of the sidewall insert of this invention is comprised of a rubber composition containing a dispersion of a particulate ultra high molecular weight polyethylene and/or a dispersion of a particulate starch/plasticizer composite.

Therefore, for said alternative aspect, said inner segment and/or said outer segment may be of a rubber which contains said ultra high molecular weight polyethylene and said inner and/or said outer segment may contain said particulate starch/plasticizer composite.

Accordingly, for said alternative aspect, said radially inner segment may contain said ultra high molecular weight polyethylene and said radially outer segment may contain said starch/plasticizer or, alternately, said radially outer segment may contain said ultra high molecular weight polyethylene and said radially inner segment may contain said starch/plasticizer.

Alternately, for said alternative aspect, said radially inner rubber segment and/or said radially outer rubber segment may contain said ultra high molecular weight polyethylene to the exclusion of said starch/plasticizer composite.

Alternately, for said alternative aspect, said radially inner rubber segment and/or said radially outer rubber segment may contain said starch/plasticizer composite to the exclusion of said ultra high molecular weight polyethylene.

Alternately, both of said radially inner rubber segment and said radially outer rubber segment may contain both of said ultra high molecular weight polyethylene and said starch/plasticizer composite.

For the purposes of the alternative aspect of this invention, it is envisioned that said particulate ultra high molecular weight polyethylene has a number average molecular weight in a range of about 4.5 to about 8, alternatively about 5 to 8, million and a melting point, according to ISO Method No. 306, in a range of about 130° C. to about 150° C.

For the purposes of the alternative aspect of this invention, it is envisioned that said starch/plasticizer composite is a particulate composite of starch and plasticizer having a softening point in a range of from about 110° C. to about 170° C.

It is understood that one skilled in the pertinent art may appropriately select combinations of elastomers, reinforcing fillers, and optionally one or more additional reinforcing and/or non-reinforcing fillers (e.g. clays and short fibers), and, optionally said ultra high molecular weight polyethyethylene and/or starch/plasticizer composite to, in general, provide rubber compositions for said segments of said sidewall rubber insert with appropriate modulus and hardness values without undue experimentation.

In further accordance with this invention, such pneumatic tire is provided comprised of two spaced apart beads, circumferential tread and a rubber sidewall extending radially outward from each of said beads to a peripheral edge of said tread, wherein at least one of said rubber sidewalls contains said annular sidewall rubber insert composed of said two overlapping segments positioned internally within said sidewall.

In one aspect, said annular rubber sidewall insert is an apex typically having an entruncated substantially crescent shape with the entruncated base of the apex being juxtapositioned to said bead portion.

In another aspect, said spaced apart annular sidewall rubber insert may be of a substantially crescent shape.

In practice, the said radially inner rubber segment and/or said radially outer rubber segment of said insert composite may be comprised of, based upon parts by weight per 100 parts rubber (phr), so long as the respective segment has the said 100 ring modulus and said Shore D hardness properties;

(A) 100 phr of at least one elastomer selected from homopolymers and copolymers of isoprene and/or 1,3-butadiene and copolymers of styrene and at least one of isoprene and 1,3-butadiene;

(B) about 10 to about 50 phr of at least one reinforcing filler selected from carbon black, precipitated silica, aluminosilicate and silica-containing carbon black having silica domains on its surface within said rubber composition of said segment; and

(C) a coupling agent for said silica, aluminosilicate, silica-containing carbon black and starch composite, as the case may be, having a moiety reactive with hydroxyl groups (e.g. silanol groups) contained on the surface of said precipitated silica, aluminosilicate and said silica domains of said silica-containing carbon black and hydroxyl units contained in said starch composite, as the case may be, and another moiety interactive with said elastomer(s),

(D) from zero to about 50, alternatively about 5 to about 40, phr of a particulate ultra high molecular weight polyethylene having a number average molecular weight average in a range of about 4.5 to about 8, alternatively about 5 to 8, million and having a melting point according to ISO Method No. 306 in a range of about 130° C. to about 150° C., dispersed within said rubber composition of at least one of said segments;

(E) from zero to about 40, alternatively about 5 to about 30, phr of a particulate starch/plasticizer composite dispersed within said rubber composition of at least one of said segments; and

(F) optionally, one or more additional reinforcing and/or non-reinforcing materials (e.g. comprised of at least one particulate materials selected from, for example, clay, cured rubber (particles) and short fibers such as, for example, short fibers of glass and organic materials such as cotton, rayon, nylon and aramid fibers).

Therefore the inclusion of the ultra high molecular weight polyethylene (UHMWPE) and/or starch/plasticizer composite is an optional feature of the invention.

In practice, said starch is typically composed of amylose units and amylopectin units in a ratio of about 15/85 to about 35/65, alternatively about 20/80 to about 30/70, and has a softening point in a range of about 180° C. to about 220° C.

In practice, said starch/plasticizer composite has a softening point in a range of about 110° C. to about 170° C. and said plasticizer is a polymeric plasticizer having a softening point of less than 160° C.; wherein said softening points are determined according to ASTM No. D1228.

For the optional starch/plasticizer composite additive to at least one of the said segments of said insert composite, it is considered herein that use of a starch/plasticizer in combination with the ultra high molecular weight polyethylene (UHMWPE) dispersion in said segment of said sidewall insert, inclusions (micro dispersions) can be used to obtain a higher modulus of the rubber composition at relatively low strains (e.g.: 100 percent elongation) as a result of, at least in part, elastomer/UHMWPE/starch composite interactions.

For the purposes of this invention, it is believed that a significant contribution of optional micro inclusion, or dispersion, of the ultra high molecular weight polyethylene (UHMWPE) is to promote a significantly higher modulus of the rubber composition at relatively low strains (e.g.: 100 percent elongation).

In practice, the segmented, or graduated, sidewall insert may be prepared, for example, by co-extrusion of two individual suitable rubber compositions (to form the two overlapping segments of the sidewall rubber insert) through a suitable extruder(s) and through a suitable die to form a shaped co-extruded strip, following which the strip is built into a tire assembly and the resulting assembly cured in a suitable mold under conditions of elevated temperature and pressure.

In practice, the said reinforcing filler for the said first and second segments may be comprised of, for example, carbon black, silica or a combination of carbon black and silica, particularly precipitated silica in combination with a coupling agent, with the selection and amounts being individually tailored for each segment according to the physical properties desired without undue experimentation by one having skill in such art. For example, such reinforcing filler may be comprised of, for example,

(A) carbon black alone,

(B) about 20 to about 30 phr of carbon black and about 10 to about 60 phr of precipitated silica and/or aluminosilicate and optionally about 5 to about 20 phr of said starch/plasticizer composite,

(C) about 30 to about 50 phr of carbon black and optionally about 10 to about 30 phr of said starch/plasticizer composite or

(D) about 15 to about 30 phr of carbon black, about 20 to about 40 phr of silica-containing carbon black (carbon black which domains of silica on its surface) and optionally about 5 to about 30 phr of said starch/plasticizer composite.

It is to be appreciated that a coupling agent is to be typically used in combination with said precipitated silica, aluminosilicate, with said silica-containing carbon black and with said starch/plasticizer composite to aid in coupling such fillers to the elastomer(s) and to, thus, enhance their elastomer reinforcing effect. Such couplers are those which have a moiety reactive with hydroxyl groups (e.g. silanol groups) contained on the surface of the silica, aluminosilicate and silica-containing carbon black or the surface of the starch/plasticizer composite (e.g. hydroxyl groups) and another moiety interactive with the elastomer(s).

The philosophy of utilizing coupling agents for such purpose is well known to those having skill in such art.

For the optional starch/plasticizer composite, it is to be appreciated that starch has previously been suggested for use in rubber products, including starch/plasticizer composites. For example, see U.S. Pat. No. 5,762,639.

Starch is typically represented as a carbohydrate polymer having repeating units of amylose (anhydroglucopyranose units joined by glucosidic bonds) and amylopectin, a branched chain structure, as is well known to those having skill in such art. Typically, starch is composed of about 25 percent amylose and about 75 percent amylopectin (The Condensed Chemical Dictionary, Ninth Edition (1977), revised by G. G. Hawley, published by Van Nostrand Reinhold Company, Page 813). Starch can be, reportedly, a reserve polysaccharide in plants such as, for example, corn, potatoes, rice and wheat as typical commercial sources.

It is considered herein that use of the optional starch/plasticizer composition, or compositions, with a softening point significantly lower than that of the starch alone, can allow the starch to be more easily mixed and processed in conventional elastomer processing equipment.

In practice, a plasticizer for said optional starch/plasticizer composite may be comprised of a poly(ethylenevinyl alcohol). A starch to plasticizer weight ratio may be, for example, in a range of about 0.5/1 to about 5/1, alternatively about 1/1 to about 5/1, so long as the starch/plasticizer composition has the required softening point range, and preferably, is capable of being a free flowing, dry powder or extruded pellets, before it is mixed with the elastomer(s).

Various blends of starch and ethylenevinyl alcohol copolymers can then be prepared according to mixing procedures well known to those having skill in such art.

It is understood that one having skill in the pertinent art can readily tune the physical properties for the appropriate rubber compositions for the inserts without undue experimentation by the inclusion of the additional reinforcing and/or non-reinforcing materials (e.g. clay and/or short fibers) as well as adjustment of any pertinent ingredient in the rubber composition(s), including curatives (e.g. sulfur and sulfur cure accelerators).

### BRIEF DESCRIPTION OF THE DRAWINGS

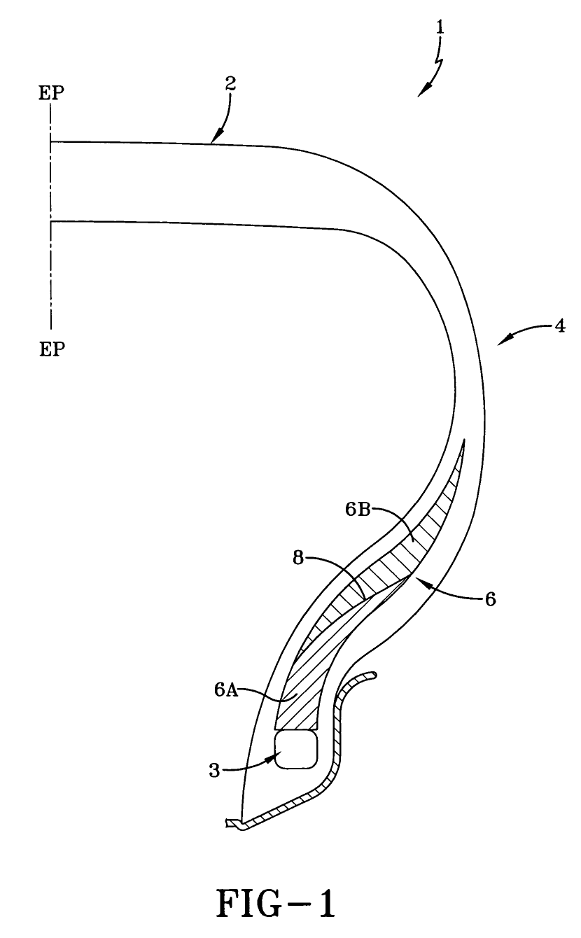

For a further understanding of the invention, reference is made to the accompanying drawings in which FIGS. 1 through 4 are presented which depict a partial cross-section of a tire having one or more internal sidewall rubber inserts.

### THE DRAWINGS

In the drawings, a partial cross-sectional view of pneumatic tire (1) is shown with a circumferential tread (2), bead portion (3) and sidewall portion (4) extending radially outward from said bead portion (3) to said tread (2).

In FIG. 1, the sidewall portion (4) contains an internal co-extruded two-segment sidewall rubber insert in a form of an apex (6). The apex (6) is of a tapered shape extending from the bead portion (3) radially outward with its apex terminating in the sidewall (4).

The apex (6), primarily because of its positioning relatively low in the sidewall and adjacent to the bead portion (3) is normally be expected to experience mainly compressive forces as the tire is run under load. However, since the radially outer component (6B), or segment, of the apex (6) is understood to work within the sidewall (4) primarily under tension, a rubber composition for the component (6B) would desirably have a lower stiffness than the radially inner component (6A) and would be expected to have a higher ultimate elongation physical property.

The apex (6) is composed of, or configured as, two overlapping co-extruded rubber segments, namely:

(A) a first segment (6A) as a radially inner component of the apex (6) extending radially outward from the bead portion (3), and

(B) a second segment (6B) as a radially outer component of the apex (6) extending radially outward from said inner segment (6A) further into said sidewall portion (4);

wherein said inner segment (6A) and said outer segment (6B) are in an overlapping configuration with a diagonal interface (8) therebetween forming an overlapping zone,

wherein said outer segment (6B) is of an overall thinner cross-section than said inner segment (6A).

For the purposes of this drawing presentation, the rubber composition of said inner segment (6A) is a significantly tougher (greater 100 percent ring modulus) and harder (greater Shore D hardness) rubber composition than the rubber composition of said outer segment (6B) of the apex (6).

In particular, for the purposes of this drawing, the rubber composition of the outer rubber segment (6B) has a 100 percent ring modulus (at 23° C.) of about 6 MPa and a Shore D hardness of about 30 and the rubber composition of the overlapping, inner rubber segment (6A) has a 100 percent ring modulus (at 23° C.) of about 15 MPa and a Shore D hardness of about 43.

Therefore, the apex (6) may be characterized by having a graduated stiffness provided by both the individual segments of differing modulus and hardness properties and, also, by the overlapping configuration of the segments.

In FIG. 2, the sidewall portion (4) contains the two-segment apex (6) of FIG. 1 together with an additional, spaced apart, sidewall insert (7) spaced apart from and extending radially outward from the apex (6) in an overlapping relationship with the apex (6) in which the spaced apart overlapping portion of the spaced apart sidewall insert (7) is axially inward of the apex (6).

The spaced apart sidewall insert (7), because of its positioning radially further outward into the tire sidewall, would normally be expected to experience a combination of compression and extension forces.

For the purposes of this drawing, the spaced apart sidewall insert (7) is of a unitary rubber composition having modulus and hardness values similar to those of the rubber composition of said inner apex segment (6A), namely a 100 percent ring modulus (at 23° C.) of about 15 MPa and a Shore D hardness of about 43.

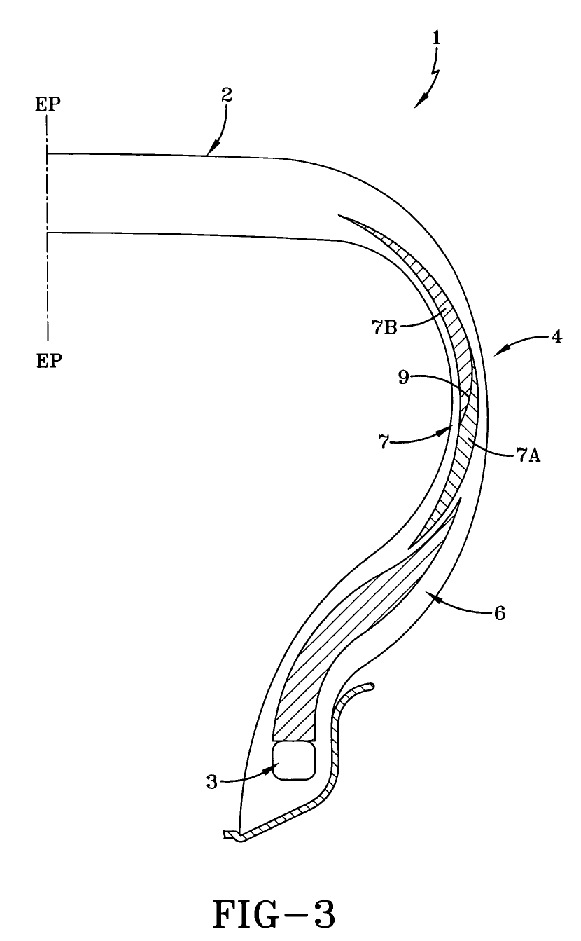

In FIG. 3, the sidewall portion (4) contains a sidewall apex (6) similar in shape to the two-segment apex (6) of FIG. 1 except that the apex is of a unitary rubber composition, together with a an additional spaced-apart sidewall insert (7) of the shape and positioning as the additional spaced-apart sidewall insert (7) of FIG. 2 except that the spaced-apart sidewall insert for FIG. 3 is composed of a co-extruded two-segment insert, namely a radially inner segment (7A) and a radially outer segment (7B).

In particular, the spaced apart sidewall insert (7) is composed of, or configured as, two overlapping co-extruded rubber segments, namely:

(A) a first segment (7A) as a radially inner component of the insert, and

(B) a second segment (7B) as a radially outer component of the sidewall insert (7) extending radially outward from said inner segment (7A) further into said sidewall portion (4) and approaching a tread portion (2) of the tire (1);

wherein said radially inner segment (7A) and said radially outer segment (7B) are in an overlapping configuration with a diagonal interface (9) therebetween forming an overlapping zone.

For the purposes of this drawing presentation, namely FIG. 3, the rubber composition of said radially outer segment (7B) is of a significantly tougher and harder rubber composition than the rubber composition of said radially inner segment (7A).

In particular, for the purposes of this drawing, the rubber composition of the radially outer rubber segment (7B) has a 100 percent ring modulus (at 23° C.) of about 15 MPa and a Shore D hardness of about 43 and the rubber composition of the overlapping radially inner rubber segment (7A) has a 100 percent ring modulus (at 23° C.) of about 6 MPa and a Shore D hardness of about 30.

Therefore, the spaced apart sidewall rubber insert (7) may be characterized by having a graduated stiffness provided by both the individual segments of differing modulus and hardness properties and, also, by the overlapping configuration of the segments.

For the purposes of this drawing, the rubber composition of the apex (6) of unitary rubber composition has the modulus and hardness properties of segment (6A) of the apex (6) presented in FIG. 1.

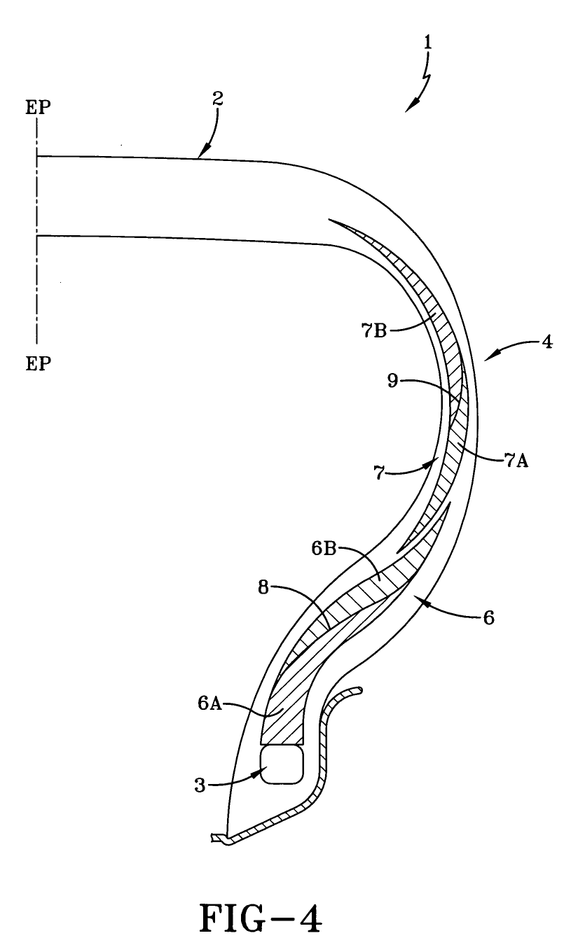

In FIG. 4, the sidewall portion (4) contains the co-extruded two-segment sidewall apex (6) of the shape, positioning and composition of the apex (6) of FIG. 2 and the spaced apart two segmented sidewall rubber insert (7) of the shape, positioning and composition of the spaced apart sidewall rubber insert (7) of FIG. 3.

For consideration of this drawing, a cord reinforced rubber ply (not shown) is envisioned for the Figures which is contained in the sidewall (4) and extends from the bead portion (3) through the crown portion of the tire (not identified in the drawing) radially inward of the tire tread portion (2) to the opposite bead portion (not shown) of the tire. For FIGS. 2, 3, and 4, it is envisioned that the ply is positioned between said apex (6) and said spaced apart sidewall rubber insert (7) in which the spaced apart sidewall rubber insert is thereby positioned adjacent to and axially inward from the ply. For all of the Figures, the apex (6) is envisioned as being positioned adjacent to and axially outward from the ply. The ply is envisioned as extending to the axially inward side of the bead (3) and apex (6), then around the radially inward part of the bead portion (3) to thereafter, in what is typically referred to as a ply turn-up portion, extending to the axially outward side of the bead portion (3) and apex (6) for a relatively short distance radially outward into the tire sidewall (4). Such ply with its ply turn-up portion is well known to those having skill in such art in which the apex (6) is therefore adjacent to and axially outward of the ply and adjacent to and axially inward of the ply turn-up.

It is readily understood by those having skill in the art that the rubber compositions used for the insert for this invention, particularly the segments of the insert, may be prepared, or compounded, by methods generally known in the rubber compounding art without undue experimentation to achieve the aforesaid 100 percent modulus and Shore D hardness physical properties, such as mixing the various sulfur-vulcanizable constituent rubbers with various commonly used additive materials, as may be appropriate, such as, for example, curing aids, such as sulfur, activators, retarders and accelerators, processing additives, such as oils, resins including tackifying resins, particulate reinforcement as hereinbefore discussed, and plasticizers, fillers, pigments, fatty acid, zinc oxide, waxes, antioxidants and antiozonants and peptizing agents. As known to those skilled in the art, depending on the intended use of the sulfur-vulcanizable and sulfur-vulcanized material (rubbers), the additives mentioned above are selected and commonly used in conventional amounts as appropriate.

The tire can be built, shaped, molded and cured by various methods which will be readily apparent to those having skill in such art.

While certain representative embodiments and details have been shown for the purpose of illustrating the subject invention, it will be apparent to those skilled in this art that various changes and modifications can be made therein without departing from the scope of the subject invention.

1. A pneumatic tire comprised of a circumferential tread, two spaced apart beads, and sidewalls connecting said beads and tread, wherein said tire sidewall contains at least one internal annular sidewall insert composed of co-extruded first segment and second segment, wherein a portion of said first segment and a portion of said second segment are in a overlapping configuration with each other with a diagonal interface therebetween to form an overlapping zone,
(A) wherein for first and second rubber segments of said sidewall insert;
(1) the rubber composition of said first rubber segment has a 100 percent ring modulus at 23° C. within a range of about 10 to about 20 MPa and a Shore D hardness value at 23° C. within a range of about 30 to about 55;
(2) the rubber composition of said second rubber segment has a 100 percent ring modulus at 23° C. within a range of about 3 to about 12 MPa and Shore D hardness value at 23° C. within a range of about 25 to about 35;
(3) said 100 percent ring modulus of said rubber composition of said first rubber segment is at least five MPa greater than said 100 percent ring modulus of the rubber composition of said second rubber segment; and
(4) said Shore D hardness of said rubber composition of said first rubber segment is at least five units greater than the Shore D hardness of the rubber composition of said second rubber segment;
(B) wherein said tire sidewall contains:
(1) an apex composed of said sidewall rubber insert extending from a tire bead radially outward into said tire sidewall, wherein said first rubber segment of said apex is a radially inner component thereof and said second rubber segment of said apex is a radially outer component thereof, or
(2) an apex and an additional said sidewall rubber insert wherein said additional sidewall insert is spaced apart from said apex, extends radially outward and axially inward from said apex in an overlapping relationship therewith, wherein
(a) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
(b) for said spaced apart sidewall insert, said first rubber segment of said spaced apart sidewall rubber insert is a radially outer component thereof and said second rubber segment of said spaced apart sidewall rubber insert is a radially inner component thereof, or
(3) an apex and an additional said sidewall rubber insert wherein said additional sidewall insert is spaced apart from said apex, extends radially outward and axially inward from said apex in an overlapping relationship therewith, wherein
(a) said apex extends radially outward from a tire bead into a tire sidewall, wherein said apex is of a unitary rubber composition, and;
(b) for said spaced apart sidewall insert, said first rubber segment of said spaced apart sidewall rubber insert is a radially outer component thereof and said second rubber segment of said spaced apart sidewall rubber insert is a radially inner component thereof, or
(4) an apex and an additional said sidewall rubber insert wherein said additional sidewall insert is spaced apart from said apex, extends radially outward and axially inward from said apex in an overlapping relationship therewith, wherein
(a) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
(b) said spaced apart sidewall insert is comprised of a unitary rubber composition, or
(5) an apex and an additional said sidewall rubber insert wherein said additional sidewall insert is spaced apart from said apex, extends radially outward and axially inward from said apex in an overlapping relationship therewith, wherein
(a) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
(b) for said spaced apart sidewall insert, said second rubber segment of said spaced apart sidewall rubber insert is a radially outer component thereof and said first rubber segment of said spaced apart sidewall rubber insert is a radially inner component thereof, or
(6) an apex and an additional said sidewall rubber insert wherein said additional sidewall insert is spaced apart from said apex, extends radially outward and axially inward from said apex in an overlapping relationship therewith, wherein
(a) said apex extends radially outward from a tire bead into a tire sidewall, wherein said apex is of a unitary rubber composition, and;
(b) for said spaced apart sidewall insert, said first rubber segment of said spaced apart sidewall rubber insert is a radially inner component thereof and said second rubber segment of said spaced apart sidewall rubber insert is a radially outer component thereof.

2. The tire of claim 1 wherein said overlapping zoned configuration of the radially inner segment and radially outer segment of said sidewall insert comprises from about 20 to about 50 percent of the radial length of each of said segments of said sidewall segments and from about 10 to 30 percent of the radial length of the sidewall insert.

3. The tire of claim 1 wherein a said sidewall insert is characterized by having a radially graduated stiffness formed by significant differences between the 100 percent ring modulus and Shore D hardness of the radially aligned individual segments in a cooperative combination with the said overlapping configuration of the two segments.

4. The tire of claim 2 wherein a said sidewall insert is characterized by having a radially graduated stiffness formed by significant differences between the 100 percent ring modulus and Shore D hardness of the radially aligned individual segments in a cooperative combination with the said overlapping configuration of the two segments.

5. The tire of claim 1 wherein said tire sidewall contains an apex composed of said sidewall rubber insert extending from a tire bead radially outward into said tire sidewall, wherein said first rubber segment of said apex is a radially inner component thereof and said second rubber segment of said apex is a radially outer component thereof.

6. The tire of claim 1 wherein said tire sidewall contains an apex and an additional said sidewall rubber insert wherein said additional sidewall insert is spaced apart from said apex, extends radially outward and axially inward from said apex in an overlapping relationship therewith, wherein
(A) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
(B) for said spaced apart sidewall insert, said first rubber segment of said spaced apart sidewall rubber insert is a radially outer component thereof and said second rubber segment of said spaced apart sidewall rubber insert is a radially inner component thereof.

7. The tire of claim 1 wherein said tire sidewall contains an apex and an additional said sidewall rubber insert wherein said additional sidewall insert is spaced apart from said apex, extends radially outward and axially inward from said apex in an overlapping relationship therewith, wherein
(A) said apex extends radially outward from a tire bead into a tire sidewall, wherein said apex is of a unitary rubber composition, and;
(B) for said spaced apart sidewall insert, said first rubber segment of said spaced apart sidewall rubber insert is a radially outer component thereof and said second rubber segment of said spaced apart sidewall rubber insert is a radially inner component thereof.

8. The tire of claim 1 wherein said sidewall contains an apex and an additional said sidewall rubber insert wherein said additional sidewall insert is spaced apart from said apex, extends radially outward and axially inward from said apex in an overlapping relationship therewith, wherein
(A) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
(B) said spaced apart sidewall insert is comprised of a unitary rubber composition.

9. The tire of claim 1 wherein said sidewall contains an apex and an additional said sidewall rubber insert wherein said additional sidewall insert is spaced apart from said apex, extends radially outward and axially inward from said apex in an overlapping relationship therewith, wherein
(A) said apex is composed of said tire sidewall rubber insert extending from a tire bead radially outward into said tire sidewall, wherein said first rubber segment of said apex is a radially inner component thereof and said second rubber segment of said apex is a radially outer component thereof, and;
(B) for said spaced apart sidewall insert, said second rubber segment of said spaced apart sidewall rubber insert is a radially outer component thereof and said first rubber segment of said spaced apart sidewall rubber insert is a radially inner component thereof.

10. The tire of claim 1 wherein said sidewall contains an apex and an additional said sidewall rubber insert wherein said additional sidewall insert is spaced apart from said apex, extends radially outward and axially inward from said apex in an overlapping relationship therewith, wherein
(A) said apex extends radially outward from a tire bead into a tire sidewall, wherein said apex is of a unitary rubber composition, and;
(B) for said spaced apart sidewall insert, said first rubber segment of said spaced apart sidewall rubber insert is a radially inner component thereof and said second rubber segment of said spaced apart sidewall rubber insert is a radially outer component thereof.

11. The tire of claim 1 wherein said radially inner rubber segment and/or said radially outer rubber segment of said two-segment sidewall rubber insert is comprised of, based upon parts by weight per 100 parts rubber (phr), so long as said segments have said 100 percent ring modulus and Shore D hardness properties;
(A) 100 phr of at least one elastomer selected from homopolymers and copolymers of isoprene and/or 1,3-butadiene and copolymers of styrene and at least one of isoprene and 1,3-butadiene;
(B) about 10 to about 50 phr of at least one reinforcing filler selected from carbon black, precipitated silica, aluminosilicate and silica-containing carbon black having silica domains on its surface within said rubber composition of said segment; and
(C) a coupling agent for said silica, aluminosilicate, silica-containing carbon black and starch composite, as the case may be, having a moiety reactive with hydroxyl groups (e.g. silanol groups) contained on the surface of said precipitated silica, aluminosilicate and said silica domains of said silica-containing carbon black and hydroxyl units contained in said starch composite, as the case may be, and another moiety interactive with said elastomer(s),
(D) from zero to about 50, alternatively about 5 to about 40, phr of a particulate ultra high molecular weight polyethylene having a number average molecular weight average in a range of about 4.5 to about 8, alternatively about 5 to 8, million and having a melting point according to ISO Method No. 306 in a range of about 130° C. to about 150° C., dispersed within said rubber composition of at least one of said segments;
(E) from zero to about 40, alternatively about 5 to about 30, phr of a particulate starch/plasticizer composite dispersed within said rubber composition of at least one of said segments; and
(F) optionally, at least one reinforcing and/or non-reinforcing particulate filler and/or short fibers.

12. The tire of claim 1 wherein at least one of said radially inner rubber segment and/or said radially outer rubber segment of said two-segment sidewall rubber insert is comprised of a rubber composition which contains from about 5 to about 40 phr of a dispersion of an particulate ultra high molecular weight polyethylene.

13. The tire of claim 1 wherein at least one of said radially inner rubber segment and/or said radially outer rubber segment of said two-segment sidewall rubber insert is comprised of a rubber composition which contains from about 5 to about 30 phr of a dispersion of a starch/plasticizer composite having a starch to plasticizer weight ratio in a range of from about 0.5/1 to about 5/1 and said rubber segments are exclusive of said ultra high molecular weight polyethylene.

14. The tire of claim 1 wherein at least one of said radially inner rubber segment and/or said radially outer rubber segment of said sidewall rubber insert is comprised of a rubber composition which contains from about 5 to about 40 phr of a dispersion of high molecular weight polyethylene and said rubber segments are exclusive of a starch/plasticizer composite.

15. The tire of claim 2 wherein said radially inner rubber segment and/or said radially outer rubber segment of said two-segment sidewall rubber insert is comprised of, based upon parts by weight per 100 parts rubber (phr), so long as said segments have said 100 percent ring modulus and Shore D hardness values;
(A) 100 phr of at least one elastomer selected from homopolymers and copolymers of isoprene and/or 1,3-butadiene and copolymers of styrene and at least one of isoprene and 1,3-butadiene;
(B) about 10 to about 50 phr of at least one reinforcing filler selected from carbon black, precipitated silica, aluminosilicate and silica-containing carbon black having silica domains on its surface within said rubber composition of said segment; and
(C) a coupling agent for said silica, aluminosilicate, silica-containing carbon black and starch composite, as the case may be, having a moiety reactive with hydroxyl groups (e.g. silanol groups) contained on the surface of said precipitated silica, aluminosilicate and said silica domains of said silica-containing carbon black and hydroxyl units contained in said starch composite, as the case may be, and another moiety interactive with said elastomer(s),
(D) from zero to about 50, alternatively about 5 to about 40, phr of a particulate ultra high molecular weight polyethylene having a number average molecular weight average in a range of about 4.5 to about 8, alternatively about 5 to 8, million and having a melting point according to ISO Method No. 306 in a range of about 130° C. to about 150° C., dispersed within said rubber composition of at least one of said segments; and:
(E) from zero to about 40, alternatively about 5 to about 30, phr of a particulate starch/plasticizer composite dispersed within said rubber composition of at least one of said segments.

16. The tire of claim 2 wherein at least one of said radially inner rubber segment and/or said radially outer rubber segment of said two-segment sidewall rubber inserts is comprised of a rubber composition which contains from about 5 to about 40 phr of a dispersion of an particulate ultra high molecular weight polyethylene and at least one of said radially inner rubber segment and/or said radially outer rubber segment of said two-segment rubber sidewall inserts is composed of a rubber composition which contains from 5 to about 30 phr of a particulate starch/plasticizer composite.

17. The tire of claim 2 wherein at least one of said radially inner rubber segment and/or said radially outer rubber segment of said two-segment sidewall rubber insert is comprised of a rubber composition which contains from about 5 to about 30 phr of a dispersion of a starch/plasticizer composite where the starch to plasticizer weight ratio is in a range of from about 0.5/1 to about 5/1 and said rubber segments are exclusive of said ultra high molecular weight polyethylene.

18. The tire of claim 11 wherein at least one of said radially inner rubber segment and/or said radially outer rubber segment of said two-segment sidewall rubber insert is comprised of a rubber composition which contains at least one of said additional reinforcing and/or non-reinforcing materials comprised of at least one of particulate material selected from clay, cured rubber and short fibers.

19. The tire of claim 1 wherein said tire sidewall contains said apex and said spaced apart sidewall rubber insert, wherein tire sidewall contains at least one cord reinforced ply and wherein at least one of said plies is positioned between said apex and said spaced apart sidewall rubber insert.

20. The tire of claim 19 wherein said apex is positioned adjacent to and axially outward from at least one of said plies and said spaced apart sidewall rubber insert is positioned adjacent to and radially inward from at least one of said plies.
